(19) United States
(12) Patent Application Publication
(10) Pub. No.: US 2007/0011190 A1
(43) Pub. Date: Jan. 11, 2007

(54) Legal document generating system

(76) Inventor: Randolph L. Finney, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/413,681

(22) Filed: Apr. 27, 2006

Related U.S. Application Data
(63) Continuation of application No. 10/199,864, filed on Jul. 18, 2002, now abandoned.
(63) Continuation-in-part of application No. 11/323,348, filed on Dec. 30, 2005, now abandoned.
Application No. 11/323,348 is a continuation of application No. 10/163,548, filed on Jun. 5, 2002, now abandoned.
(60) Provisional application No. 60/357,556, filed on Feb. 15, 2002.

(51) Int. Cl. G06F 7/00

(52) U.S. Cl. 707/102

(57) ABSTRACT

A system and method for generating divorce proceedings or other paperwork. The system includes a server computer system and a user computer system coupled to a network. The server computer system includes a memory that stores location-based divorce proceeding rules, and a processor with a graphical user interface component. The user computer system includes a user interface component coupled to a processing component. The user interface component presents the graphical user interfaces generated by the graphical user interface component and receives responses to the presented graphical user interfaces. The responses include a selection for the location for the divorce proceedings. The received responses are sent to the server computer system. The graphical user interface component generates graphical user interfaces based on at least one of the location selection or other received responses. The processor automatically generates completed divorce documents based on the received responses.

### PRIORITY CLAIM

This application is a continuation of application Ser. No. 10/199,864, filed Jul. 18, 2002 and is a continuation-in-part of application Ser. No. 11/323,348, filed Dec. 30, 2005, which is a continuation of Ser. No. 10/163,548, filed Jun. 5, 2002, which claims the benefit of provisional application Ser. No. 60/357,556, filed Feb. 15, 2002 all of which are incorporated by reference in their entirety herein.

### FIELD OF THE INVENTION

This invention relates generally to document generating systems and methods, including documents for use in divorce filings and other legal proceedings.

### BACKGROUND OF THE INVENTION

In many legal proceedings the major costs are associated with the time and expertise required to generate the required paperwork. The time and expertise are often required even when the legal proceeding itself is essentially a formality. For example, in an uncontested divorce proceeding, there are a number of documents that must be prepared and filed. The act of completing the proper documents is a tedious one that requires some experience in reading and understanding their content and format. Because the paperwork can be confusing and time consuming, those filing for divorce often turn to attorneys to assist them.

Presently there are a number of sources of blank forms and document templates that are useful for legal proceedings such as divorces. While these tools can be helpful in some instances, even completing the blank forms can be daunting in many cases. Therefore, there exists a need to aid a layperson in the process of filling out legal paperwork, especially divorce documents.

### SUMMARY OF THE INVENTION

The present invention comprises a system and method for automatically generating documents such as those required in divorce proceedings and other legal actions. A preferred embodiment of the system includes a server computer system and a user computer system coupled to a network. The server computer system includes a memory that stores location- based divorce proceeding rules, a processor, and a graphical user interface component. The user computer system includes a user interface component coupled to a processing component. The user interface component presents the graphical user interfaces generated by the graphical user interface component and receives responses to the presented graphical user interfaces. The responses include a selection for the location of the divorce proceedings. The received responses are sent to the server computer system. The graphical user interface component generates graphical user interfaces based on at least one of the location selection or other received responses. The processor automatically generates completed divorce documents based on the received responses.

In accordance with further preferred aspects of the invention, the processor automatically calculates child support payments based on the responses.

In accordance with other preferred aspects of the invention, the presented graphical user interfaces comprise one or more questions, brief explanations of the questions, and a hyperlink to the legal statute or other authority related to the questions.

In accordance with still further preferred aspects of the invention, the processor automatically generates completed divorce documents based on the information provided by the user and the appropriate geographical location of the court or other governing body.

In accordance with yet other preferred aspects of the invention, spousal and child support are also automatically generated.

In accordance with still another aspect of the invention, the user computer system is configured to retrieve the generated documents over the network.

In accordance with additional preferred aspects of the invention, the processor generates instructions for reviewing and filing the generated documents.

As will be readily appreciated from the foregoing summary, the invention provides a system and method for reducing the time and cost associated with preparing certain documents, including those for use in divorce proceedings.

### BRIEF DESCRIPTION OF THE DRAWINGS

The preferred and alternative embodiments of the present invention are described in detail below with reference to the following drawings.

FIG. 1 is a system diagram of a preferred embodiment of the present invention;

FIGS. 2A-B are flow diagrams of preferred embodiments of the present invention; and

FIGS. 3-6A and 6B are screen displays of an example network-based graphical user interface formed in accordance with the present invention for performing the process shown in FIGS. 2A-B.

### DETAILED DESCRIPTION OF THE PREFERRED EMBODIMENT

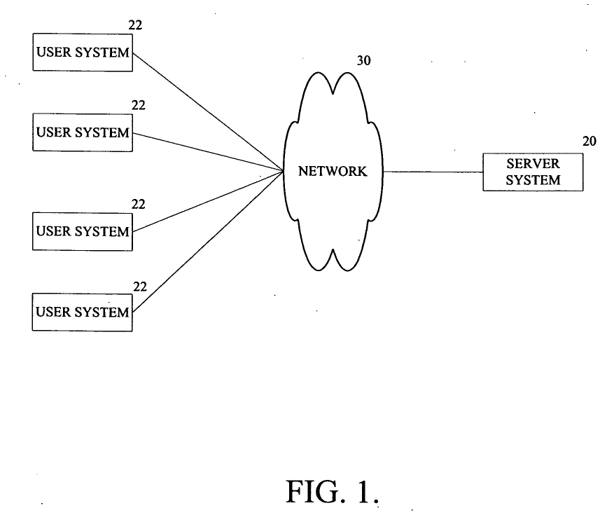

As shown in FIG. 1, the present invention is an automatic legal document generating and calculating system 18. The term “automatic,” as used in this specification to describe the automatic preparation of forms, shall mean that such forms are prepared by the system in an automated fashion, rather than by a user operating word processing or other software. It does not mean that the user need not register a mouse click, key stroke, or take other action before the forms are actually generated. Likewise, it does not necessarily mean that the forms are prepared at a particular speed or at a certain time. Rather, it means that the forms are compiled by the system based on user input, rather than being directly prepared by the user.

A preferred embodiment of the system 18 includes a plurality of user systems 22 and a server system 20 in communication over a public or private network 30, such as the Internet. The server system 20 generates interactive webpages that guide a user at a user system 22 through a questioning session designed to gather the information necessary to complete the divorce proceeding paperwork. Once all the questions have been answered by a user at a user system 22, the server system 20 automatically generates the necessary court documents and calculates child support and alimony based upon the answers the user supplied in response to questions included in the interactive webpages. An application program executed by the server system 20 generates the interactive webpages based on previously entered information regarding laws in a particular state, county, or city; child support and alimony payment algorithms for those state, counties, or cities; personal tax and financial information, and case law information.

The questioning session includes a plurality of questions that are stored in memory at the server system 20. The questions are stored in a tree-like structure. In the tree-like structure, the questions occupy nodes that are linked to one or more other nodes. Sometimes the link between nodes is based on the answer to the question at one of the nodes. For example, if a question at node N is “Are there any children involved?” and the answer is yes, the questions in a child questionnaire branch of nodes in the tree-like structure are presented in order. The last node in the child questionnaire branch of nodes is in one example linked to the same node that node N is linked to if the answer to the node N question is no.

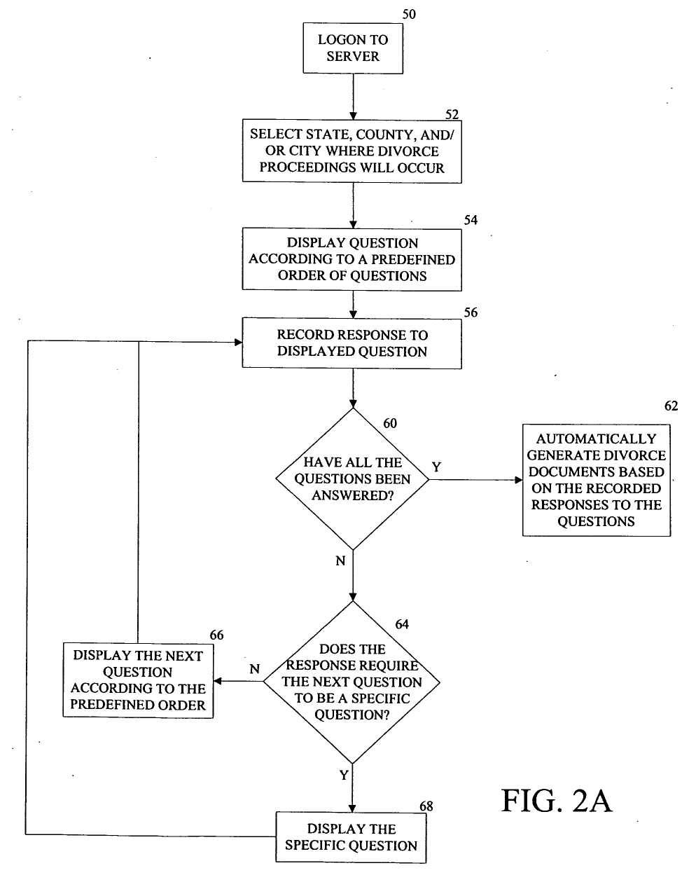

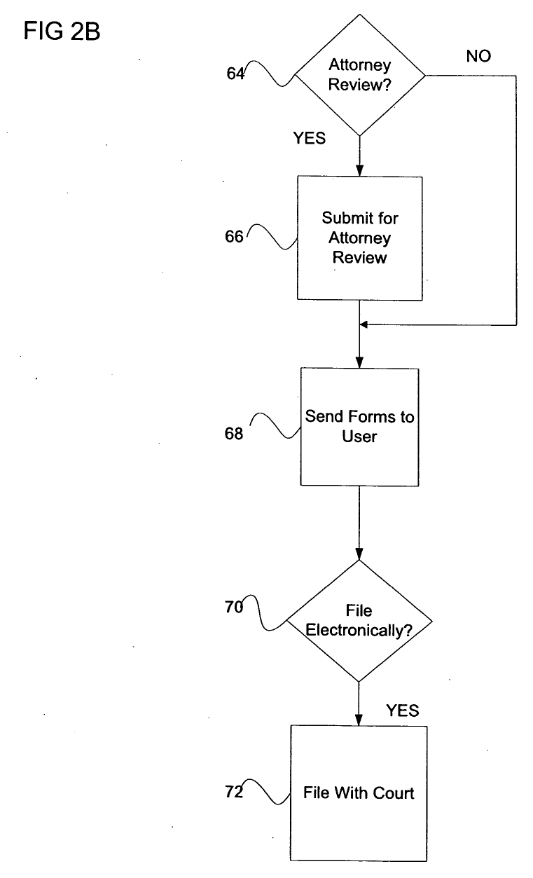

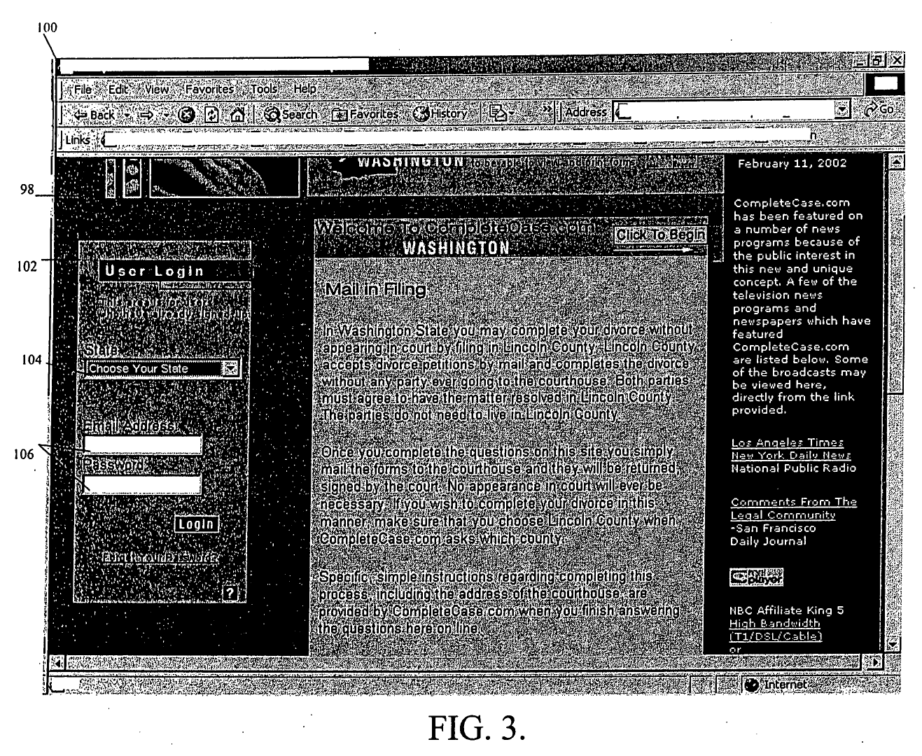

While the preferred form of the invention incorporates interactive WebPages exchanged over the Internet, other structures are also possible. For example, the entire method as illustrated in FIGS. 2A-B and the screen displays illustrated in FIGS. 3-6 may be incorporated in a software product distributed as a stand-alone program stored on a disk, CD-ROM, or other media. Likewise, the software product may be wholly or partially distributed to the user system 22 at some point after accessing the server 20, so that some or all of the processing occurs at the user system. Regardless of the form, it is preferable for the system to provide access to the server system 20 by the user system 22, for example to obtain attorney review or answers to specific questions.

FIGS. 2A-B illustrate a flow diagram of a preferred process performed by the network-based embodiment of the system 18 shown in FIG. 1. First, at block 50, a user at a user system 22 logs onto the server system 20 over the network 30. The server system 20 requires a secure password before a user can interact with interactive webpages generated by an application program executed by the server system 20.

Next, at block 52, the user selects the state where divorce proceedings are to occur. The selection of a particular state is not necessarily required. The system may be configured so that it only prepares forms for a particular state. In such an embodiment, separate websites or software products may be created for individual states. Alternatively, courts of different states may accept legal documents that are standardized, so that the preparation need not vary by state. For embodiments in which forms for multiple states having different requirements may be prepared, the system requests the user to indicate a particular state.

Then, at block 54, the application program retrieves and displays a question according to a predefined order of questions that is based on information required for the selected state. The question is displayed on interactive webpages, examples of which are shown in FIGS. 3-6 and described in more detail below. At block 56, a user using the user interface at a corresponding user system 22 answers the displayed question. At block 56, the user's answer to the displayed question is recorded for possible later use in document generation. At decision block 60, the process determines whether all the questions have been answered. If it is determined that all the questions have been answered, the server system 20 automatically generates the required divorce documents for the selected state, county, or city based on the recorded responses to the questions and prestored algorithms for performing various calculations, such as child support, child custody or parenting plans, and alimony.

The prestored algorithms for calculating child support and alimony payments are government sanctioned algorithms or algorithms that are presently being used manually. The prestored algorithms that calculate alimony or child support payments are based upon appropriate statutory and other legal authority, as well as the tax and financial information of both parties of the divorce (for example, it properly accounts for tax related deductions). Because the server system 20 stores the algorithms and the application program, updates and changes to either can be easily performed.

If it is determined at decision block 60 that not all the questions have been answered, the process determines if the recently recorded response requires that the next question be a specific follow-up question. For example, if the question is “Do you have children?” and the answer to that question is yes, the next question in the session is a specific follow-up question to a divorce proceeding where children are involved. Thus, the follow-up questions may inquire, for example, as to the number of children, their ages, tax exemption claiming, and others. If it is determined at decision block 64 that the response does not require a specific follow-up question, the process proceeds to the next question according to a predefined base question sequence, see block 66. After block 66, the process returns to block 56, allowing the user to respond to the question and the system to record responses to questions. If at decision block 64 there does exist a specific question related to the response, the specific question is displayed to the user, see block 68. After block 68, the process returns to block 56.

The specific questions asked are designed to gather information required to prepare various documents as required by the applicable court. Thus, for example, the system will ask questions sufficient to obtain information to prepare a typical petition for dissolution marriage that may include the date and location of the marriage, names and ages of children, property owned, debts and liabilities, whether spousal maintenance is required, pregnancy status, and a desired parenting plan having any bases for restrictions as well as residential scheduling, decision making, and other components.

The above method employs a question and answer format, requesting users to answer a series of questions to obtain information to populate the legal forms. As an alternative, the system may ask users to enter all of the same information in fields in a form, so that the user essentially sees all of the questions at once, rather than iteratively. In either configuration, the system solicits the information and verifies that the needed information has been provided.

Once the system has received a confirmation that all questions have been answered, it proceeds to block 62 to generate the legal forms for filing. As noted above, the documents are prepared automatically, meaning that the system uses the information to generate forms having the information in the proper format. Before the forms are generated, however, the user may be required to instruct the system to do so or to indicate another preference such as sending the forms to a printer, disk, email address, or other location.

After the forms are completed, the user may review and sign them, then file them with the court as required. Along with the generated forms, the user receives instructions regarding the processing of the forms, such as who must sign them, where to file them, and whether other persons must receive a copy.

While the system will generate forms automatically that are suitable for filing, certain users may prefer to obtain an attorney review of the generated documents. As shown in FIG. 2B, the system asks the user whether an attorney review is desired at block 64. If the users answer yes, the generated documents are automatically sent to an attorney for review, block 66. Preferably, the attorney will receive copies of the documents via an email attachment, with a message instructing the attorney regarding the required review. Alternatively, the attorney may receive an email without the documents attached. In such an embodiment, the attorney may access the server 20 to obtain them, or may receive them by facsimile or some other means.

During the course of attorney review, the attorney will evaluate the forms for any applicable issues, such as legal compliance, format errors, grammatical concerns, or other matters. The attorney will revise the generated documents as necessary, then send an acknowledgment along with the documents back to the server, which will, in turn, forward the documents automatically to the user. Alternatively, the attorney may work with the documents exclusively on the server, so that they need not be sent back to the server. In another embodiment, the attorney will send the revised documents directly to the user, bypassing the server. In such an embodiment, it is preferable to also update the documents on the server or any other associated data storage media so that accurate records are maintained.

The system next asks the user whether the documents are to be filed electronically with the court or other office, block 70. As part of this inquiry, it is preferable to indicate all such locations that are to receive electronic copies. If electronic filing is desired, the system proceeds to block 72 for electronic filing. The format of the documents for electronic filing may vary from that required for paper filing. For example, a specific court may require that electronically filed documents be given specific file names and be formatted as PDF files. Consequently, the system will modify the documents as required to ensure that they are in the proper format. Once the documents are properly formatted, they are filed with the court and also sent electronically to any other addressee, preferably by email, as requested by the user.

Many of the above steps can be performed in a different order, within the scope of the invention. For example, inquiries regarding attorney review and electronic filing can be made much earlier, including as an initial intake process for the user. Likewise, the user can receive copies of the forms before they are sent to an attorney for review as well as after such review.

FIG. 3 illustrates a log-in interactive webpage 98 generated by the application program and presented in a window 100 on a display device of the user system 22. The log-in interactive webpage 98 includes a log-in area 102 that includes a state selection pull-down menu 104 and identification and password log-in area 106. Using an input device, the user selects the state in which to file for divorce from the pull-down menu 104. Though the user can independently select a filing location, the system also suggests one or more locations that may be preferred by the user. For example, at the webpage 98 at which the user is to select a filing location, the system presents one or more locations that may be desirable because filing can be accomplished by mail, filing fees are low, or other attributes.

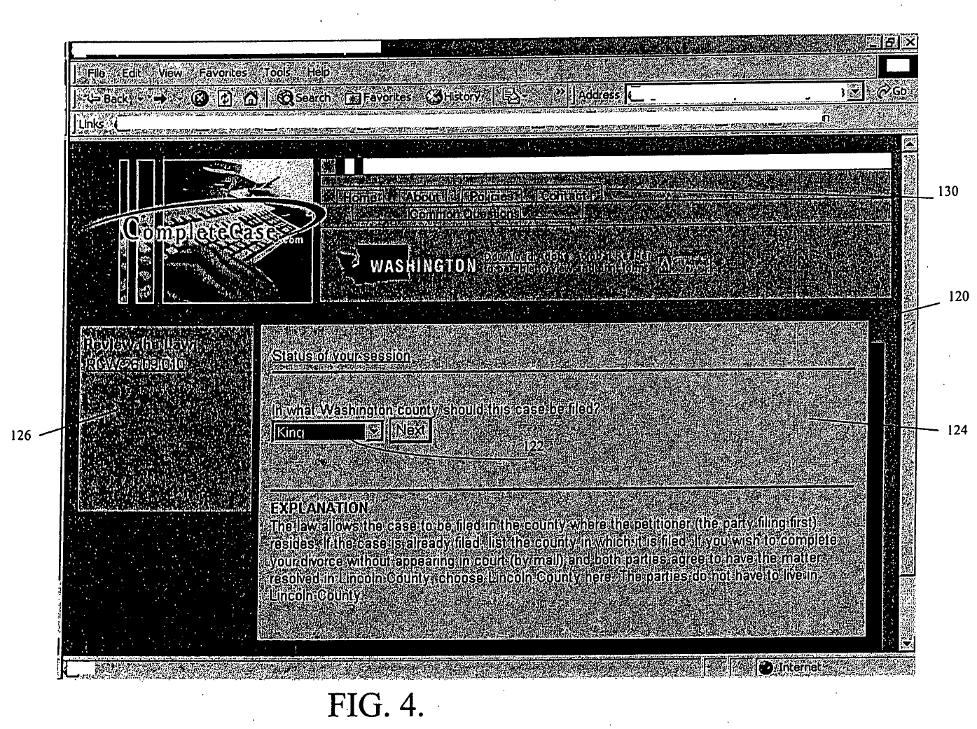

FIG. 4 illustrates a county selection window 120 that includes a county selection pull-down menu 122, similar to the state pull-down menu 104. Some or all of the following interaction areas appear in most or all of the interactive webpages generated by the application program: a question area 124, a law review area 126, and a website button area 130. The question area 124 displays each question, preferably one at a time with an explanation paragraph accompanying and associated with the displayed question. The question area 124 includes hyperlink text to a webpage that indicates the status of the present user session. Displayed adjacent to the question area 124 is the law review area 126. The law review area 126 includes hyperlinks to the specific legal recitations that are associated with the question or questions displayed in the question area 124.

In an alternate embodiment, the law review area 126 also includes a link to a live attorney for specific advice. The link preferably is associated with an email window, such that when the link is selected the email window will appear on the screen. The user may then prepare an email that is pre-addressed to an attorney so that it will automatically be sent to an attorney when the user indicates that it should be sent. The attorney is associated with the server system and will receive and respond to the question from the user.

The website button area 130 includes various buttons that allow a user to ask or view common questions about the system and how it works, find out contact information, review policy information of the entity operating the server system 20, review general information about the website, and to jump to the initial page of the website.

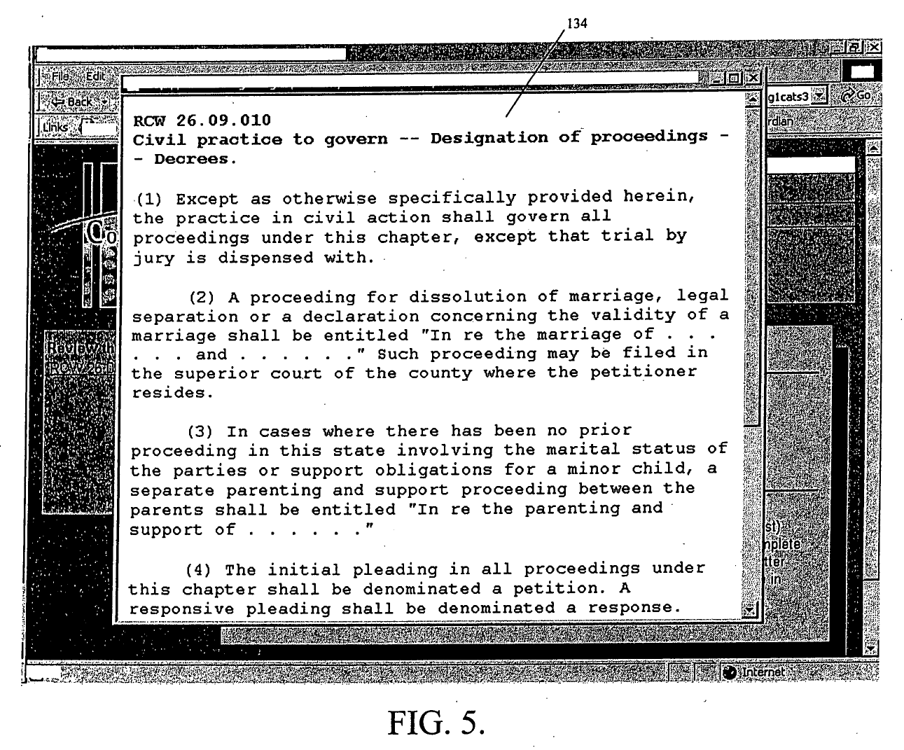

FIG. 5 illustrates a law review window 134 that is retrieved and displayed upon selection of an associated hyperlink text in the law review section 126. The information displayed in window 34 is a selection of the law that relates to the question presently displayed in the question area 124. Although the preferred hyperlink is a textual reference to a statute or other legal authority, the hyperlinks may alternatively be graphical.

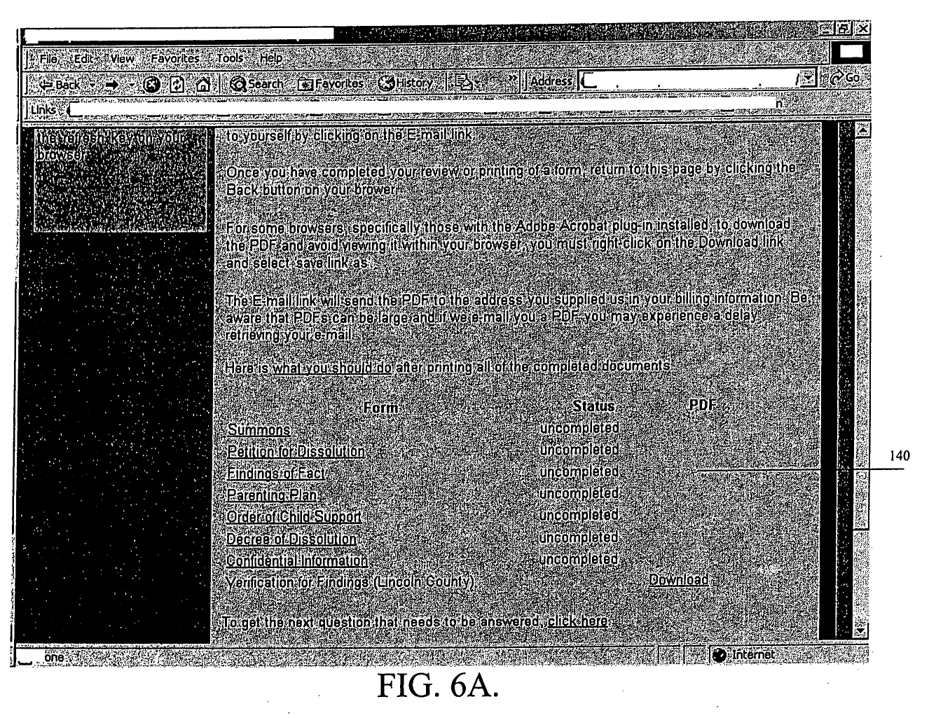

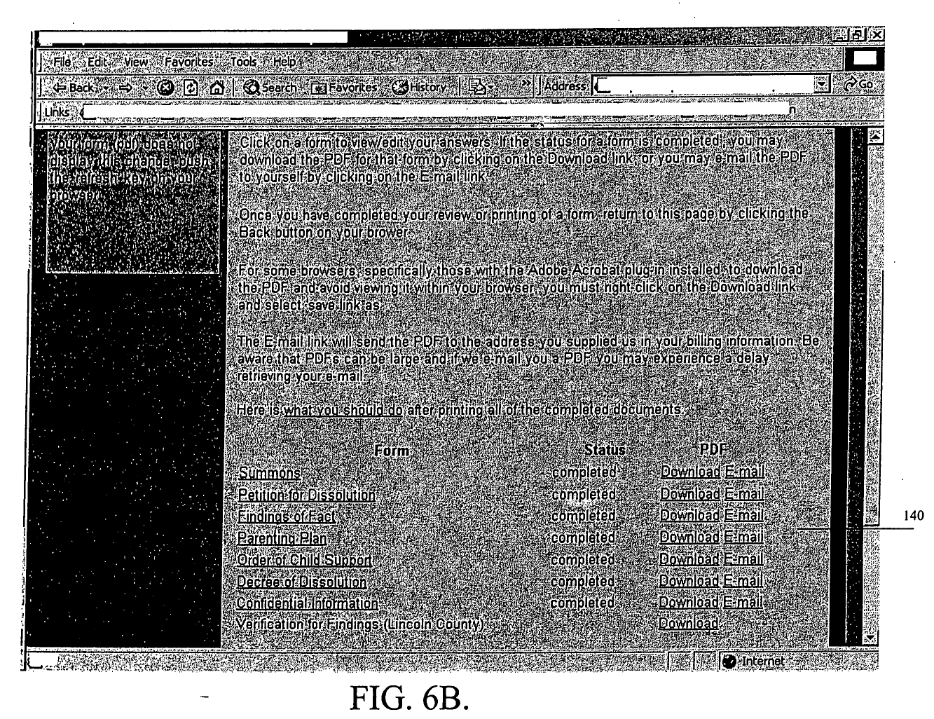

FIGS. 6A and B illustrate a status page that is retrieved and displayed upon selection of the status hyperlink included in the question area 124. The status window includes a status information area 140 that presents the completion status of various legal documents associated with the present session. After a document has been automatically generated upon question session completion or upon completion of the questions that are required for completing the document, the status area 14 presents hyperlinks that allow a user to download or e-mail a generated legal document. Selection of the download hyperlink allows for direct downloading of the legal document in a document format, such PDF or other formats, to the user system 22. Selection of the e-mail hyperlink allows for e-mail delivery of the created legal documents to a destination of choice.

In the particular example of FIG. 6A, the page illustrates the status of all the divorce documents for a user that has not answered enough questions to complete even one of the documents. FIG. 6B, on the other hand, illustrates the status of legal documents as it relates to a user that has completed all the questions presented to the user. The documents that are automatically generated by the present invention include but are not limited to a summons, a petition for dissolution, findings of fact, parenting plan, order of child support, decree of dissolution, confidential information, verification of findings, and a child support schedule.

Also stored at the server system 20 are document filing or court procedure rules or guidelines for the place they designated for their divorce proceedings. The document filing or court procedure rules or guidelines are viewable or printable at a user system 22 at the end of a session, or upon request. The guidelines provide instructions for the user related to completing and filing the forms after they have been downloaded. For example, the instructions explain who must sign the forms, whether they must be served upon a spouse, where to mail or send them, the appropriate filing fee that must be submitted, whether notarization is required, and when and where the user must appear in court (if applicable). Along with the guidelines, the system provides a checklist of many of the above items for review by the user before filing the papers with the court.

In an alternate embodiment, the system will prepare legal documents in a desired language based upon information entered by the user in a different language. For example, the system will prepare forms in English based upon information received in Spanish. The bilingual aspect of the invention may be incorporated in several ways. In a first embodiment, the stored questions (e.g., FIG. 2, block 54) are stored in a plurality of languages. The system initially asks the user to indicate a preferred language to conduct the inquiry. The questions are then presented in the selected language.

The translation aspect of the invention may be incorporated at varying levels of sophistication. In one embodiment, the system presents the questions in a selected language but only receives answers in the language used for completed documents, such as English. In such an embodiment, the user must be able to answer in English. This simple structure may be acceptable, for example, where the answers given are short or single words such as the names of family members, yes or no, or annual income levels.

In an alternate embodiment, the answers are accepted in the selected language for subsequent translation to the target language. The actual translation may occur in an automated fashion or with the aid of translators. Presently, there are translation computer software programs available that will readily and accurately translate entries from one language into another. In the preferred form of the invention, a translation module is incorporated such that the questions and answers are provided in the desired language and the answers are translated to the target language automatically by the translation module. Preferably, the user's responses are recorded in both languages for complete record-keeping. Once the responses are translated, the system proceeds in the same fashion as if the answers were provided in the target language in the first instance. Where translations are used, however, it may be preferable to incorporate an attorney review or other method to verify accuracy.

The translation module may also be incorporated within the attorney advice function. Thus, the user will indicate a preferred language to use, then prepare an email to the attorney as described above. The translation module will automatically translate the question to English (or any other target language) for transmission to the attorney. To verify accuracy, the message is preferably sent to the attorney both in the original and target languages.

While the preferred embodiment of the invention has been illustrated and described, as noted above, many changes can be made without departing from the spirit and scope of the invention. Although the present invention has been described in the greatest detail with regard to the preparation of divorce filings, it is also applicable to other automatically generated forms. Accordingly, the scope of the invention is not limited by the disclosure of the preferred embodiment.

1. A network based system for generating divorce proceedings paperwork, the system comprising:
a server computer system coupled to a network and accessible by a user computer over the network, the server computer system comprising:
a memory for storing divorce proceeding rules and a graphical user interface component; and
a processor;
wherein the graphical user interface component is operable by the processor to generate graphical user interfaces that solicit from the user computer information related to a divorce proceeding; and
further wherein the processor generates a completed divorce document based on the information received from the user computer.

2. The system of claim 1, wherein the graphical user interfaces comprises an option by which the user may request an attorney response to a query.

3. The system of claim 2, wherein the option for attorney response further comprises a window to prepare and send an email to an attorney.

4. The system of claim 3, wherein the option for attorney response further comprises a translation component for translating the query from a first language to a second language.

5. The system of claim 4, wherein the email further comprises the query in both the first language and the second language.

6. A method for generating divorce proceedings paperwork, the method comprising:
displaying questions to a user relating to the divorce proceedings;
recording responses to each of the displayed questions;
generating a completed divorce document based on the recorded responses to the questions;
calculating child support payments based on the recorded responses to displayed questions;
displaying law that relates to the divorce proceedings; and
downloading the generated document to a user system over a public data network.

7. The method of claim 6, further comprising submitting the document to an attorney for review.

8. The method of claim 7, further comprising evaluating the document for at least one of legal compliance, format errors and grammatical concerns.

9. The method of claim 6, further comprising formatting the document for electronically filing the document with a court.

10. The method of claim 9, further comprising automatically electronically filing the document with a court.

11. The method of claim 6, further comprising calculating alimony payments based on the recorded responses to displayed questions.

12. The method of claim 11, wherein calculating alimony is determined by at least one of statutory, legal, tax, and financial information.

13. The method of claim 6, further comprising determining the jurisdiction of the proceeding.

14. The method of claim 13, wherein the generated document is formatted according to published court rules for a selected jurisdiction.

15. The method of claim 14, further comprising evaluating property under statutory rules for community property in the selected jurisdiction.

16. The method of claim 15, further comprising providing a user with detailed instructions on how to file the divorce documents in the selected jurisdiction.

17. A computer-readable medium having computer-executable instructions for performing steps comprising:
generating at least one graphical user interface that solicits from a user information related to a divorce proceeding;
generating at least one of a pull-down menu that solicits from the user a selection of a jurisdiction in which the divorce proceeding is to be filed, a data-entry field into which the user can enter the name of a jurisdiction in which the divorce proceeding is to be filed, and a graphical user interface allowing the user to select a first jurisdiction in which the divorce proceeding is to be filed, the first jurisdiction being of a plurality of jurisdictions within a second jurisdiction;
generating a completed divorce document based on the information received from the user; and
electronically filing the completed divorce document with an administrative entity.
